(19) United States
(12) Patent Application Publication
(10) Pub. No.: US 2009/0001083 A1
(43) Pub. Date: Jan. 1, 2009

(54) GARBAGE CAN LINER

(75) Inventors: Kenneth A. Murdock, Springville, UT (US); Ramona Wilson, Santaquin, UT (US)

Correspondence Address: STOEL RIVES LLP - SLC, 201 SOUTH MAIN STREET, ONE UTAH CENTER, SALT LAKE CITY, UT, 84111, US

(73) Assignee: MI LLC, Springville, UT (US)

(21) Appl. No.: 11/768,774

(22) Filed: Jun. 26, 2007

(51) Int. Cl. B65F 1/06; B65D 30/00

(52) U.S. Cl. 220/495.06; 383/120

(57) ABSTRACT

An embodiment of a garbage collection system includes a receptacle comprising a top portion, a bottom portion, and an interior cavity, the top portion comprising an opening into the interior cavity, a liner for insertion through the opening into the interior cavity of the garbage receptacle, and an attachment mechanism disposed between the bottom portion of the garbage receptacle and the liner, the attachment mechanism for detachably securing the liner to the bottom portion of the garbage receptacle.

### TECHNICAL FIELD

An embodiment relates to a garbage can liner and techniques for detachably securing the garbage can liner to a garbage can.

### BACKGROUND

Garbage cans or other garbage receptacles are ubiquitous features of homes, offices, and virtually all public spaces. So too are the bags or liners that shield the garbage cans or receptacles from the garbage therein and aid safe and sanitary disposal thereof.

Often the garbage cans or receptacles are relegated to locations that hide their aesthetically displeasing appearance. The garbage bag or garbage can liner inserted into the garbage can or garbage receptacle is often the culprit. As a result, and often to the detriment of its function, a garbage can or receptacle may be hidden under a desk, inside a cabinet, or otherwise obstructed from view. Unfortunately, hiding the garbage can or receptacle or otherwise setting the can or receptacle aside may impede the availability of the garbage can or receptacle for waste disposal.

Numerous approaches exist to secure a garbage bag or liner to the garbage can or receptacle. A simple method is to fold excess bag or liner material over the top opening of the can or receptacle. Further methods elasticize one or more portions of the bag or liner opening to engage the can or receptacle to detachably hold the bag or liner in place. For bags or liners that are too large or contain excess material (e.g., given that the variety of cans or receptacles may exceed the variety of bag or liner sizes available) often the bag or liner is knotted to decrease the size of the bag or liner opening so that the bag or liner more substantially engages the can or receptacle to secure the bag or liner in place.

Further, U.S. Pat. No. 5,987,708 to Newton describes a garbage bag restraint to detachably secure a garbage liner to a garbage container, in particular when the liner is larger than the garbage container. Generally, Newton discloses a pocket-sized plastic restraint including a ridged edge and a flexible gripping center to grip a gathered portion of the liner. More specifically, the flexible gripping center is a serrated opening that bites into the gathered liner like teeth to hold the bag tightly without cutting it. Further included in the plastic restraint is a tucking strip opening in which excess liner may be tucked.

The present inventor has recognized the desirability of increasing the aesthetics of garbage cans or receptacles and their respective bags and liners while simultaneously increasing the functionality of each.

### BRIEF DESCRIPTION OF THE DRAWINGS

FIG. 1 is a side view of a garbage can including a liner of an embodiment;

FIG. 2 is a side view of a garbage can including a liner of an alternate embodiment;

FIG. 3 is a top view of the inside base of the garbage can including a puck to detachably engage the liner of an embodiment;

FIG. 4A is a side view of the puck of an embodiment including flexible arms;

FIG. 4B is a side view of the puck of an embodiment and the liner of an embodiment that includes a plug to detachably engage the liner to the puck;

FIG. 4C is a side view of the puck of an embodiment detachably engaging the liner of an embodiment;

FIG. 5 is a side view of a plunger of an embodiment including protrusions to insert the liner into the garbage can;

FIG. 6A is a top view of the plunger of FIG. 5;

FIG. 6B is a top view of the plunger of an alternate embodiment including roller bearings around its circumference;

FIG. 6C is a top view of the plunger of another embodiment including a serration around its circumference; and

FIG. 6D is a top view of the plunger of yet another embodiment including retractable fingers.

### DETAILED DESCRIPTION OF PREFERRED EMBODIMENTS

Embodiments of a garbage collection system including a garbage can liner and method and apparatus for inserting the garbage can liner into a garbage can or receptacle will be described. Reference will now be made in detail to a description of these embodiments as illustrated in the drawings. While the embodiments will be described in connection with these drawings, there is no intent to limit them the drawings disclosed herein. On the contrary, the intent is to cover all alternatives, modifications, and equivalents within the spirit and scope of the described embodiments as defined by the accompanying claims.

Simply stated, an embodiment is a garbage can or receptacle liner is disclosed, including one or more decorative and functional elements. For example, the liner of an embodiment may resemble tissue paper inserted into the garbage can or receptacle by incorporating a plurality of undulating and non-uniform creases and the like. An alternate embodiment may contain a plurality of folds substantially uniformly distributed around the circumference of the liner, each parallel with a longitudinal axis of the garbage can or receptacle. The liner of each embodiment may detachably engage the bottom of the garbage can or receptacle by way of, for example, a puck of an embodiment that includes flexible fingers to interact with the liner. Each liner may further be inserted into the garbage can or receptacle with the plunger of an embodiment. The plunger of an embodiment may aid the interaction of the liner with the puck and/or facilitate forming a particular decorative shape as the liner is inserted into the garbage can or receptacle.

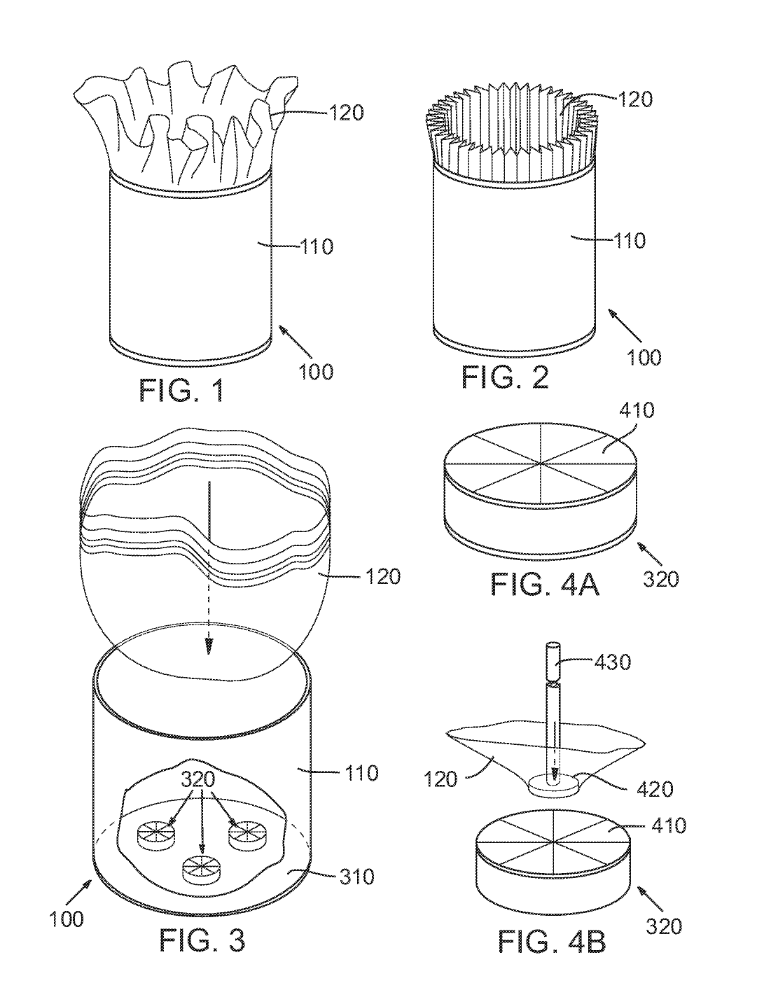

FIG. 1 illustrates a garbage collection system 100 including garbage can 110 and garbage can liner 120. Though illustrated as substantially cylindrical, it is to be understood that the garbage can 110 may have substantially any shape capable of collecting garbage. The garbage can liner 120 of an embodiment, before it is inserted into garbage can 110, may be a planar sheet of material. In one embodiment, the garbage can liner 120 may therefore be formed of a variety of materials including “tissue paper” having a density between about 10 and 35 grams per square meter (gsm). Other types of paper may be used, such as parchment, waxed paper, or the like. Alternatively, non-paper materials may be used, including biaxially-oriented polyethylene terephthalate (boPET) polyester film (commonly known as Mylar), fabric, metal foil, or any other material that may be formed into a substantially deformable sheet.

In one embodiment, the garbage can liner 120 may be scented or include an odor-absorbing or deodorizing agent. For instance, perfume, scent, etc., may be added to the liner material. Similarly, disinfectants such as hydrogen peroxide, chlorine, and chlorine compounds may be added to eliminate odors caused by microorganisms. Absorbent deodorizers, such as activated charcoal and silica gel, may be included to remove odorous molecules by attracting them to the adsorbent surface. Some substances, such as chlorophyll, eliminate odors by combining chemically with odorous impurities, and may added to the liner material in one embodiment. Glycols, which are disinfectant as well as deodorizing substances, may also be used. In certain embodiments, anti-bacterial agents, such as Triclosan, may be applied to the liner material.

Furthermore, the garbage can liner 120 material may or may not be moisture-resistant or -proof depending on the application of garbage collection system 100. In one embodiment, when the garbage can liner 120 is inserted into the garbage can 110 cavity, excess garbage can liner 120 material bunches up, forms undulating and non-uniform creases, or otherwise randomly deforms to create an aesthetically improved appearance for garbage collection system 100. Said alternatively, excess garbage can liner 120 material may overflow from the top of the garbage can 110, providing a bouffant appearance.

FIG. 2 illustrates a garbage collection system 100 including garbage can 110 and garbage can liner 210 of an alternate embodiment. Versus the substantially random undulations or deformations of the garbage can liner 120, garbage can liner 210 may contain a plurality of folds, creases, or corrugation substantially uniformly distributed around the circumference of the liner, each substantially parallel with a longitudinal axis of the garbage can or receptacle. Though illustrated with a particular number and size, it is to be understood that an embodiment may contain more or fewer creases. Further, though illustrated with substantially hard creases, the garbage can liner 210 may, in one embodiment, have softer or radiused creases (i.e., the crease may more substantially resemble a fillet). For each embodiment, the garbage can liner 210 may include a bottom that has a shape and size substantially similar to the bottom section of the garbage can 110 into which the garbage can liner 210 will be inserted. Like garbage can liner 120, garbage can liner 210 may therefore be formed of a variety of materials including tissue paper, waxed paper, Mylar, metal foil, or the like. The garbage can liner 120 material may or may not be moisture-resistant or -proof depending on the application of garbage collection system 100. In addition, the garbage can liner 210 may be scented or made of an odor-absorbing material.

In addition to potentially providing aesthetic improvements, the undulations or deformations of garbage can liner 120 and the plurality of substantially uniformly distributed folds of garbage can liner 210 may contribute to the functionality of each garbage can liner. For example, the increased surface area of garbage can liner offered by each embodiment may improve the garbage can liner's ability to trap and collect common items, such as chewing gum. Furthermore, the folds of garbage can liner 210 may provide rigidity to the portion of garbage can liner that extends above the garbage can 110 so that, for example, the size of the garbage can 110 may be reduced with respect to the overall volume of garbage the garbage can liner 210 is capable of handling.

FIG. 3 illustrates that garbage collection system 100 may further include a mechanism or mechanisms to detachably engage the garbage can liner 120 or 210 to the garbage can 110 in which it is inserted. For example, in one embodiment, the garbage can bottom 310 may include one or more pucks 320, which may be releasably or permanently secured to the garbage can bottom via double-sided tape, glue, or other adhesive, as discussed below. Alternatively, the puck 320 may include or be integrated with a magnet, which may be attracted to ferrous material within the garbage can bottom 310. If the garbage can bottom 310 includes only one puck 320, the puck 320 may be substantially centered on the garbage can bottom 310. For an embodiment including a plurality of pucks 320, the pucks 320 may be substantially uniformly distributed along the garbage can bottom 310. For instance, the pucks may be distributed in a triangular configuration, which holds the garbage can liner 120 or 210 in a non-rotatable configuration with respect to the garbage can bottom 310.

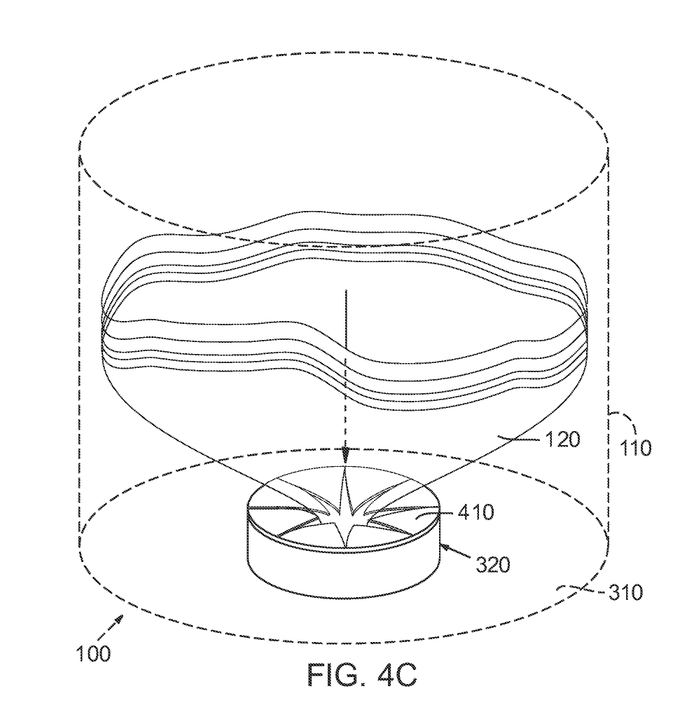

FIGS. 4A through 4C illustrate the detail and operation of puck 320. FIG. 4A illustrates that the top surface of the puck may include a plurality of flexible fingers 410 that may deform or deflect downward (i.e., toward the garbage can bottom 310) into a cavity formed by the body of the puck 320. By doing so, the flexible fingers 410 define an opening into which the bottom of garbage can liner 120 or 210 may be inserted and detachably secured as the flexible fingers return substantially to their original configuration (i.e., substantially parallel with the garbage can bottom 310). Though illustrated as being defined by uniformly spaced diameters of a circular puck 320, it is to be understood that flexible fingers 410 may be otherwise formed. For example, the flexible fingers 410 may not join at the center of puck 320 and may subsequently define an opening with which the bottom of garbage can liner 120 or 210 may be aligned or registered before insertion into the puck 320. FIG. 4C illustrates garbage can liner 120, for example, inserted into a single puck 320 and detachably engaged by flexible fingers 410.

To remove the garbage bag liner 120 or 210 from the puck 320, the garbage bag liner 120 or 210 may be pulled to deform or deflect the flexible fingers 410 away from the garbage can bottom 310. By deforming or deflecting away from the garbage can bottom 310, the flexible fingers 410 may release the garbage can liner 120 or 210 for disposal. In one embodiment, the puck 320 may be formed of a substantially elastomeric material (e.g., butadiene, styrene butadiene, butyl, ethylene propylene, fluorocarbon elastomer, fluorosilicone, natural rubber, isoprene, neoprene, nitrile, buna-N, silicone) such that the flexible fingers 410 may deform or deflect to detachably engage and disengage the garbage can liner 120 or 210 substantially without ripping or otherwise damaging the garbage can liner 120 or 210. Simultaneously, the flexible fingers 410 should not be too flexible so as to not detachably engage the garbage can liner 120 or 210 with sufficient force such that the garbage can liner 120 or 210 disengages when, for example, the garbage collection system 100 tips over or is disturbed.

FIG. 4B illustrates an alternate embodiment for which garbage can liner 120 or 210 includes one or more plugs 420 along its bottom to detachably engage one or more pucks 320 accordingly. Plug 420 may be more forcibly detachably engaged and disengaged from the puck 320 compared to the garbage can liner 120 or 210 alone. For example, a plunger 430 may exert force against the plug 420 sufficient to detachably engage the plug 420 (including garbage can liner 120 or 210) that may tear or otherwise damage the garbage can liner 120 or 210. In one embodiment, the plug 420 may be formed of a substantially rigid material such as plastic or may be a portion of the garbage can liner 120 or 210 that may be reinforced with an additional layer or multiple layers of the garbage can liner 120 or 210 material. The plug 420 may be attached to the liner 120 or 210 using an adhesive or may be applied to the liner 120 or 210 when in a liquid or semi-liquid state, such that a bond is formed when the plug 420 solidifies. A plurality of plugs 420 may be provided on the liner 120 or 210 in a layout that matches the layout of the pucks 320 on the garbage can bottom 310 (e.g., the triangular layout of FIG. 3).

Though described with reference to puck 320 interacting with garbage can liner 120 or 210 (and with plug 420 in one embodiment), it is to be understood that other detachable engagement mechanisms or methods are possible. For example, the garbage can bottom 310 and the garbage can liner 120 or 210 may share halves of a hook and loop closure system. Alternatively, the garbage can bottom 310 may include one or more patches, strips, or the like of double-sided adhesive to detachably engage the garbage can liner 120 or 210 to the garbage can bottom 310. In one embodiment, the strength of the adhesive bond between the adhesive patch, strip, or the like and the garbage can bottom 310 may exceed the strength of the adhesive bond between the adhesive patch, strip, or the like and the garbage can liner 120 or 210. In such a manner, the garbage can liner 120 or 210 may be removed from garbage can 110 without being torn or otherwise damaged while further not simultaneously removing the adhesive patch, strip, or the like from the garbage can bottom 310. In yet another embodiment, the garbage bag liner 120 or 210 may integrally include one or more adhesive patches, strips, or the like to detachably engage the garbage can bottom 310. As noted, in one embodiment, the strength of the adhesive bond between the garbage can liner 120 or 210 and the garbage can bottom 310 should be sufficient to hold the garbage can liner 120 or 210 in position if the garbage can 110 is tipped over or otherwise disturbed while not causing the garbage can liner 120 or 210 to tear or be otherwise damaged when it is removed.

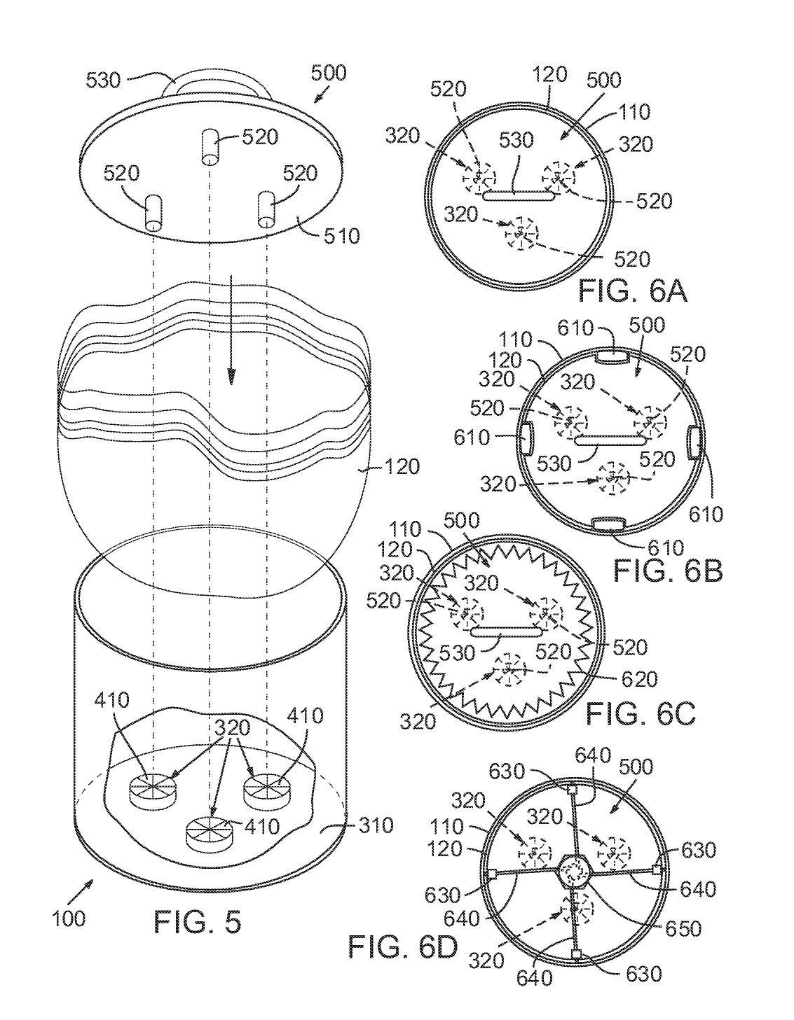

FIG. 5 illustrates the plunger 500 for inserting a garbage can liner 120 or 210 into a garbage can 110. In one embodiment, the plunger 500 may include a plunger body 510, one or more optional protrusions 520, and a handle 530 to insert and withdraw the plunger from the garbage can 110. In one embodiment, the outer diameter or cross section (e.g., if the plunger body 510 and garbage can 110 do not have a substantially circular cross section) of the plunger body 510 is smaller than the inside diameter or cross section of the garbage can 110. In one embodiment, the one or more protrusions 520 correspond to the one or more pucks 320 arranged on the garbage can bottom 310. The protrusions 520 (like singular plunger 430) operate against the bottom of garbage can liner 120 or 210 to insert a portion or multiple portions of the garbage can liner 120 or 210 into one or more pucks 320, as described above. FIG. 6A illustrates the top view of the plunger 500 to illustrate the alignment of multiple protrusions 520 with multiple pucks 320. Alternatively, the plunger 500 may have no protrusions 520, in which case the plunger 500 is used to insert and shape the liner 120 or 210 within the garbage can 110. In such an embodiment, the liner 120 or 210 may include adhesive strips, suction cups, or other mechanisms for holding the liner 120 or 210 against the garbage can bottom 310.

In one embodiment, the outer surface or circumference of the plunger body 510 may be substantially smooth and may include filleted edges to reduce the likelihood that the insertion of the plunger 500 into the garbage can 110 and retraction therefrom (e.g., after garbage can liner 120 or 210 is detachably engaged to one or more pucks 320) will tear or otherwise damage garbage can liner 120 or 210. Further, the outer surface or circumference of the plunger body 510 may include one or more additional elements to aid inserting and/or shaping the garbage can liner 120 or 210. For example, FIG. 6A illustrates an alternate embodiment of plunger 500 for which the outer surface of the plunger body 510 may include roller bearings 610 to guide the plunger 500 within the garbage can 110 while reducing friction between the outer surface or circumference of the plunger body 510 relative to the garbage can liner 110 or 120, in turn reducing the likelihood of tears or other damage during plunger 500 insertion and/or retraction.

FIG. 6C illustrates another alternate embodiment of plunger 500 for which the outer surface or circumference of the plunger body 510 may include serrations, ridges, or other uniform or non-uniform undulations 620. The inclusion of serrations, ridges, or other uniform or non-uniform undulations 620 along the periphery of the plunger body 510 may encourage in particular garbage can liner 120 to form with a particular fold or bouffant appearance.

FIG. 6D illustrates yet another embodiment of plunger 500 including one or more retractable fingers 630 that extend and retract to detachably engage and disengage the garbage can liner 120 or 210 to insert the garbage can liner 120 or 210 into the garbage can 110 and withdraw the plunger 500 respectively. The retractable fingers 630 may each be operated by a connecting rod 640 that interacts with the surface of cam 650 as is understood in the mechanical arts. The cam 650 may in turn be coupled to handle 530 or may be rotated independently to operate connecting rods 640 and retractable fingers 630. The embodiments are not limited in this context.

It will be understood by those having skill in the art that many changes may be made to the details of the above-described embodiments without departing from the underlying principles of the invention. The scope of the present invention should, therefore, be determined only by the following claims.

What is claimed is:

1. A garbage collection system comprising:
a garbage receptacle including a bottom portion and a side wall disposed around the bottom portion, the bottom portion and side wall defining an interior cavity;
a liner for insertion into the interior cavity of the garbage receptacle; and
an attachment mechanism disposed between the bottom portion of the garbage receptacle and the liner, the attachment mechanism for detachably securing the liner to the bottom portion of the garbage receptacle.

2. The garbage collection system of claim 1, wherein the attachment mechanism comprises at least one puck having a plurality radial slits on a top portion thereof, the radial slits defining a plurality of flexible fingers for detachably engaging the liner.

3. The garbage collection system of claim 2, wherein a bottom portion of the at least one puck is attached to the bottom portion of the garbage receptacle.

4. The garbage collection system of claim 3, wherein the at least one puck is attached to the bottom portion of the garbage receptacle by an adhesive.

5. The garbage collection system of claim 4, wherein the adhesive comprises double-sided tape.

6. The garbage collection system of claim 3, wherein the at least one puck is attached to the bottom portion of the garbage receptacle by a magnet integrated with the at least one puck.

6. The garbage collection of system of claim 2, further comprising a plurality of pucks arranged on the bottom portion of the garbage receptacle.

7. The garbage collection system of claim 3, wherein the liner is inserted through the radial slits on the top portion of the at least one puck such that the plurality of flexible fingers engage the liner and detachably secure the liner to the at least one puck.

8. The garbage collection system of claim 3, wherein the liner includes at least one plug for insertion through the radial slits on the top portion of the at least one puck such that the plurality of flexible fingers engage the plug and detachably secure the plug to the at least one puck.

9. The garbage collection system of claim 1, wherein the liner comprises paper having a density between about 10 and 35 grams per square meter (gsm).

10. The garbage collection system of claim 1, wherein the liner comprises biaxially-oriented polyethylene terephthalate (boPET) polyester film.

11. The garbage collection system of claim 1, wherein the liner comprises wax paper.

12. The garbage collection system of claim 1, wherein the liner comprises metal foil.

13. The garbage collection system of claim 1, wherein the liner comprises a deodorizing agent.

14. The garbage collection system of claim 1, wherein the liner comprises an antibacterial agent.

13. The garbage collection system of claim 1, further comprising:
a plunger to press the liner into the interior cavity of the garbage receptacle, the plunger comprising a disc and a handle coupled to a surface of the disc.

14. The garbage collection system of claim 13, wherein the attachment mechanism comprises at least one puck having a plurality radial slits on a top portion thereof, the radial slits defining a plurality of flexible fingers for detachably engaging the liner and detachably securing the liner to the bottom portion of the garbage can, and wherein the plunger further comprises one or more protrusions extending from the disc on an opposite side of the disc from the handle, wherein the one or more protrusions are arranged to insert the liner through the radial slits on the top portion of the at least one puck such that the plurality of flexible fingers engage the liner and detachably secure the liner to the at least one puck.

15. The garbage collection system of claim 13, wherein the attachment mechanism comprises at least one puck having a plurality radial slits on a top portion thereof, the radial slits defining a plurality of flexible fingers, and wherein the liner includes at least one plug for insertion through the radial slits on the top portion of the at least one puck such that the plurality of flexible fingers engage the plug and detachably secure the plug to the at least one puck, and wherein the one or more protrusions are arranged to insert the at least one plug through the radial slits on the top portion of the at least one puck such that the plurality of flexible fingers engage the plug and detachably secure the plug to the at least one puck.

16. A liner for a garbage receptacle, the liner comprising:
a bottom portion; and
a side wall disposed around the bottom portion to define an interior cavity, the side wall comprising a plurality of longitudinal folds substantially uniformly distributed around the bottom portion of the liner.

17. The liner of claim 16, wherein the plurality of longitudinal folds comprise corrugations.

18. The liner of claim 16, wherein the liner is substantially the same size and shape as the garbage receptacle.

19. The liner of claim 16, wherein the liner comprises paper having a density between about 10 and 35 grams per square meter (gsm).

20. The liner of claim 16, wherein the liner comprises one or more of biaxially-oriented polyethylene terephthalate (boPET) polyester film, wax paper, and metal foil,

21. The liner of claim 16, wherein the liner comprises one or more of a deodorizing agent and an antibacterial agent.
